(19) United States
(12) Patent Application Publication
(10) Pub. No.: US 2025/0362901 A1
(43) Pub. Date: Nov. 27, 2025

(54) PATCHING HARDWARE FOR PATCHING READ-ONLY MEMORY FIRMWARE

(71) Applicant: QUALCOMM Incorporated, San Diego, CA (US)

(72) Inventors: Sajith PERUMBILAVIL, Bangalore (IN); Devipriya B S, Bengaluru (IN); Shreya GARG, Bengaluru (IN); Nanda Kumar KOTHANDAPANI, RM Nagar (IN)

(21) Appl. No.: 18/671,352

(22) Filed: May 22, 2024

(51) Int. Cl. G06F 8/65

(52) U.S. Cl. CPC G06F 8/66

(57) ABSTRACT

Various aspects of the present disclosure generally relates to a computing system. In some aspects, the computing system may store patch metadata and patch code in an OTP memory. The computing system may program, before a processor of the computing system is released from a reset, the patch metadata into a patch hardware. The computing system may copy, before the processor is released from the reset, the patch code from the OTP memory into a RAM. The computing system may identify, based on the patch metadata, an access attempt issued by the processor to a bad instruction in a ROM, wherein the bad instruction is associated with ROM firmware. The computing system may direct the access attempt to the patch code stored in the RAM, wherein the ROM firmware is patched based at least in part on the patch code. Numerous other aspects are described.

### FIELD OF THE DISCLOSURE

Aspects of the present disclosure generally relate to memory systems and specifically, to techniques and apparatuses for patching hardware for patching read-only memory (ROM) firmware.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.”

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

### SUMMARY

Some aspects described herein relate to a computing system, comprising: one or more components configured to: store patch metadata and patch code in a one-time-programmable (OTP) memory of the computing system; program, before a processor of the computing system is released from a reset, the patch metadata into a patch hardware of the computing system; copy, before the processor is released from the reset, the patch code from the OTP memory into a random access memory (RAM) of the computing system; identify, based on the patch metadata, an access attempt issued by the processor to a bad instruction in a read-only memory (ROM) of the computing system, wherein the bad instruction is associated with ROM firmware; and direct the access attempt to the patch code stored in the RAM, wherein the ROM firmware is patched based at least in part on the patch code.

Some aspects described herein relate to a method performed by a computing system, comprising: storing patch metadata and patch code in an OTP memory of the computing system; programming, before a processor of the computing system is released from a reset, the patch metadata into a patch hardware of the computing system; copying, before the processor is released from the reset, the patch code from the OTP memory into a RAM of the computing system; identifying, based on the patch metadata, an access attempt issued by the processor to a bad instruction in a ROM of the computing system, wherein the bad instruction is associated with ROM firmware; and directing the access attempt to the patch code stored in the RAM, wherein the ROM firmware is patched based at least in part on the patch code.

Some aspects described herein relate to a non-transitory computer-readable medium storing a set of instructions, comprising: one or more instructions that, when executed by one or more processors of a computing system, cause the computing system to: store patch metadata and patch code in an OTP memory of the computing system; program, before a processor of the computing system is released from a reset, the patch metadata into a patch hardware of the computing system; copy, before the processor is released from the reset, the patch code from the OTP memory into a RAM of the computing system; identify, based on the patch metadata, an access attempt issued by the processor to a bad instruction in a ROM of the computing system, wherein the bad instruction is associated with ROM firmware; and direct the access attempt to the patch code stored in the RAM, wherein the ROM firmware is patched based at least in part on the patch code.

Aspects generally include a method, apparatus, system, computer program product, non-transitory computer-readable medium, memory device, or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example system capable of patching read-only memory (ROM) firmware.

FIG. 2 is a diagram of example components included in a memory device.

FIG. 3 is a diagram illustrating an example of interceptor hardware with limitations, in accordance with the present disclosure.

FIG. 4 is a diagram illustrating an example of a computing system that includes interceptor hardware, in accordance with the present disclosure.

FIG. 5 is a diagram illustrating an example of a patch layout in one-time-programmable (OTP) memory, in accordance with the present disclosure.

FIG. 6 is a flowchart of an example method associated with patching hardware for patching ROM firmware.

### DETAILED DESCRIPTION

A read-only memory (ROM) is a type of non-volatile memory used in an electronic device. Data stored in the ROM may not be electronically modified after a manufacture of the non-volatile memory. The ROM may be useful for storing firmware, which is typically not expected to require modification during a life of the electronic device.

In some cases, a ROM firmware may need to be patched (e.g., due to a failure or a vulnerability associated with the ROM firmware), which may serve to update the ROM firmware. In a first approach, patching the ROM firmware that is operational in a system on a chip (SOC) may be based at least in part on an interceptor hardware mechanism. In a second approach, patching the ROM firmware that is operational in the SOC may be based at least in part on a content-addressable memory (CAM) patch hardware mechanism.

In the first approach, interceptor hardware may intercept an access to defective ROM memory from a central processing unit (CPU), and the interceptor hardware may redirect the access to a patch code/data in a static random access memory (RAM) (SRAM). A setup of the interceptor hardware may be performed by the ROM firmware relatively early in a boot sequence. Patch metadata and/or patch code may be stored in one-time-programmable (OTP) memory. The ROM firmware may program the interceptor hardware with the patch metadata, and the ROM firmware may load the patch code into the SRAM. Since the interceptor hardware is enabled only slightly later in the boot sequence, initial ROM data may be rendered un-patchable.

In the second approach, a CAM patching may occur via CAM hardware (e.g., address matching hardware) that intercepts an access to the ROM. When the address is present in a CAM table, matching data may be returned instead of the access to the ROM being forwarded. Patched instructions may be auto-loaded by the CAM hardware into a register file from the OTP memory before the CPU is released from a reset. The CAM patching may allow the ROM to be patched from a first address onwards. However, the CAM hardware may be capable of only matching one instruction at a time, such that one instruction cannot be replaced with a multi-instruction patch.

Various aspects relate generally to patching hardware for patching ROM firmware. In some aspects, a computing system may store patch metadata and patch code in an OTP memory of the computing system. The computing system may program, before a processor of the computing system is released from a reset, the patch metadata into a patch hardware of the computing system. The computing system may copy, before the processor is released from the reset, the patch code from the OTP memory into a RAM of the computing system. The computing system may identify, based on the patch metadata, an access attempt issued by the processor to a bad instruction in a ROM of the computing system, where the bad instruction may be associated with ROM firmware. “Bad instruction” may refer to a defective instruction. The computing system may direct the access attempt to the patch code stored in the RAM, where the ROM firmware may be patched based at least in part on the patch code.

In some aspects, the patch hardware may program itself with the patch metadata. The patch code may be copied from the OTP memory into the RAM, which may occur before the processor (e.g., a CPU) is released from a reset. The patch hardware may load the patch metadata from the OTP memory and program hardware registers using the patch metadata. The patch hardware may load the patch code into the RAM before the processor is released from the reset. Since the patch code may be copied into the RAM by the patch hardware, one single ROM word may be replaced with a patch of arbitrary complexity (limited only by an available patch storage space in the OTP memory). Such a process may occur before the processor is released from the reset, such that ROM may be patched from a first instruction onwards. A ROM patch hardware may perform all necessary configurations to make the patch operational before the processor is released from the reset. As a result, ROM firmware may be patched from the very first instruction with the patch of arbitrary complexity, thereby resulting in an improvement to the ROM patch hardware.

Particular aspects of the subject matter described in this disclosure can be implemented to realize one or more of the following potential advantages. In some examples, by implementing the ROM patch hardware to perform necessary configurations to make the patch operational before the processor is released from the reset, the ROM firmware may be patched from the very first instruction. Regions of the ROM may not be un-patchable. The patch hardware may provide an ability to replace any ROM instruction/data with a complex patch. In other words, the patch hardware may not be limited to patching only one instruction at a time. As a result, a hardware mechanism to patch any part of the ROM firmware may result in an overall improved performance of a memory device.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

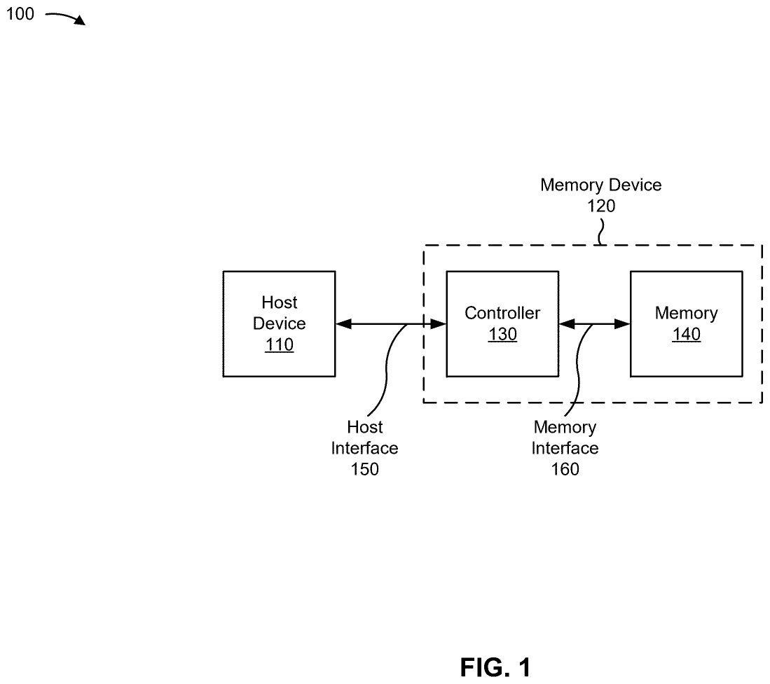

FIG. 1 is a diagram illustrating an example system 100 capable of patching ROM firmware. The system 100 may include one or more devices, apparatuses, and/or components for performing operations described herein. For example, the system 100 may include a host device 110 and a memory device 120. The memory device 120 may include a controller 130 and memory 140. The host device 110 may communicate with the memory device 120 (e.g., the controller 130 of the memory device 120) via a host interface 150. The controller 130 and the memory 140 may communicate via a memory interface 160.

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host device 110 may include one or more processors configured to execute instructions and store data in the memory 140. For example, the host device 110 may include a CPU, a graphics processing unit (GPU), a field-programmable gate array (FPGA), an application-specific integrated circuit (ASIC), and/or another type of processing component.

The memory device 120 may be any electronic device configured to store data in memory. In some implementations, the memory device 120 may be an electronic device configured to store data temporarily in volatile memory. For example, the memory device 120 may be a RAM device, such as a dynamic RAM (DRAM) device or an SRAM device. In this case, the memory 140 may include volatile memory that requires power to maintain stored data and that loses stored data after the memory device 120 is powered off. For example, the memory 140 may include one or more latches and/or RAM, such as DRAM and/or SRAM. In some implementations, the memory 140 may include non-volatile memory configured to maintain stored data after the memory device 120 is powered off, such as NAND memory or NOR memory. For example, the non-volatile memory may store persistent firmware or other instructions for execution by the controller 130.

The controller 130 may be any device configured to communicate with the host device (e.g., via the host interface 150) and the memory 140 (e.g., via the memory interface 160). Additionally, or alternatively, the controller 130 may be configured to control operations of the memory device 120 and/or the memory 140. For example, the controller 130 may include control logic, a memory controller, a system controller, an ASIC, an FPGA, a processor, a microcontroller, and/or one or more processing components. In some implementations, the controller 130 may be a high-level controller, which may communicate directly with the host device 110 and may instruct one or more low-level controllers regarding memory operations to be performed in connection with the memory 140. In some implementations, the controller 130 may be a low-level controller, which may receive instructions regarding memory operations from a high-level controller that interfaces directly with the host device 110. As an example, a high-level controller may be a solid state drive (SSD) controller, and a low-level controller may be a non-volatile memory controller (e.g., a NAND controller) or a volatile memory controller (e.g., a DRAM controller). In some implementations, a set of operations described herein as being performed by the controller 130 may be performed by a single controller (e.g., the entire set of operations may be performed by a single high-level controller or a single low-level controller). Alternatively, a set of operations described herein as being performed by the controller 130 may be performed by more than one controller (e.g., a first subset of the operations may be performed by a high-level controller and a second subset of the operations may be performed by a low-level controller).

The host interface 150 enables communication between the host device 110 and the memory device 120. The host interface 150 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, and/or an embedded multimedia card (eMMC) interface.

The memory interface 160 enables communication between the memory device 120 and the memory 140. The memory interface 160 may include a non-volatile memory interface (e.g., for communicating with non-volatile memory), such as a NAND interface or a NOR interface. Additionally, or alternatively, the memory interface 160 may include a volatile memory interface (e.g., for communicating with volatile memory), such as a double data rate (DDR) interface.

In some implementations, one or more systems, devices, apparatuses, components, and/or controllers of FIG. 1 may be configured to store patch metadata and patch code in an OTP memory of the system 100; program, before a processor of the system 100 is released from a reset, the patch metadata into a patch hardware of the system 100; copy, before the processor is released from the reset, the patch code from the OTP memory into a RAM of the system 100; identify, based on the patch metadata, an access attempt issued by the processor to a bad instruction in a ROM of the system 100, wherein the bad instruction is associated with ROM firmware; and direct the access attempt to the patch code stored in the RAM, wherein the ROM firmware is patched based at least in part on the patch code.

As indicated above, FIG. 1 is provided as an example. Other examples may differ from what is described with regard to FIG. 1.

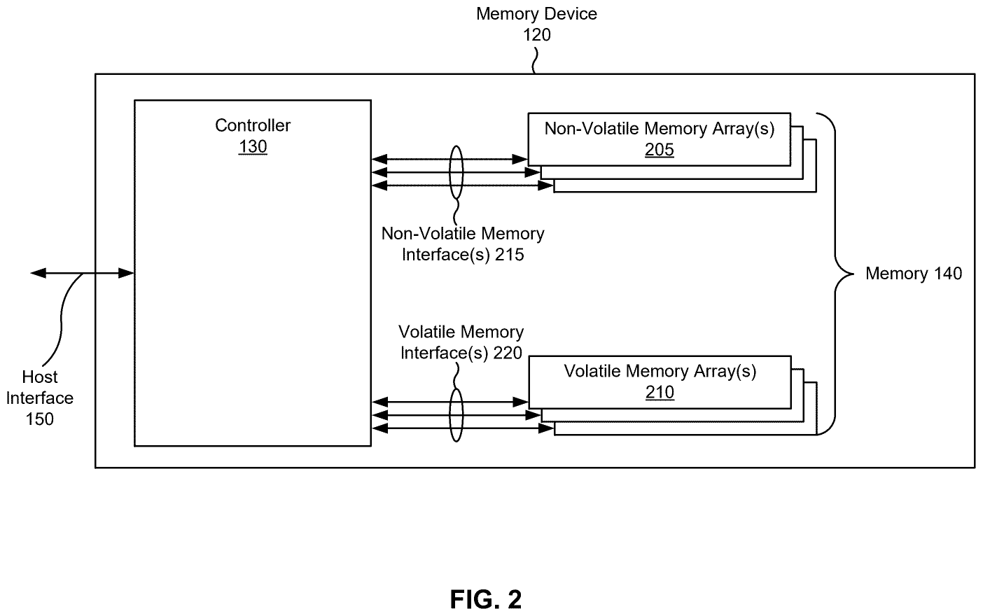

FIG. 2 is a diagram of example components included in a memory device 120. As described above in connection with FIG. 1, the memory device 120 may include a controller 130 and memory 140. As shown in FIG. 2, the memory 140 may include one or more non-volatile memory arrays 205, such as one or more NAND memory arrays and/or one or more NOR memory arrays. Additionally, or alternatively, the memory 140 may include one or more volatile memory arrays 210, such as one or more SRAM arrays and/or one or more DRAM arrays. The controller 130 may transmit signals to and receive signals from a non-volatile memory array 205 using a non-volatile memory interface 215. The controller 130 may transmit signals to and receive signals from a volatile memory array 210 using a volatile memory interface 220.

The controller 130 may control operations of the memory 140, such as by executing one or more instructions. For example, the memory device 120 may store one or more instructions in the memory 140 as firmware, and the controller 130 may execute those one or more instructions. Additionally, or alternatively, the controller 130 may receive one or more instructions from the host device 110 via the host interface 150, and may execute those one or more instructions. In some implementations, a non-transitory computer-readable medium (e.g., volatile memory and/or non-volatile memory) may store a set of instructions (e.g., one or more instructions or code) for execution by the controller 130. The controller 130 may execute the set of instructions to perform one or more operations or methods described herein. In some implementations, execution of the set of instructions, by the controller 130, causes the controller 130 and/or the memory device 120 to perform one or more operations or methods described herein. In some implementations, hardwired circuitry is used instead of or in combination with the one or more instructions to perform one or more operations or methods described herein. Additionally, or alternatively, the controller 130 and/or one or more components of the memory device 120 may be configured to perform one or more operations or methods described herein. An instruction is sometimes called a “command.”

For example, the controller 130 may transmit signals to and/or receive signals from the memory 140 based on the one or more instructions, such as to transfer data to (e.g., write or program), to transfer data from (e.g., read), and/or to erase all or a portion of the memory 140 (e.g., one or more memory cells, pages, sub-blocks, blocks, or planes of the memory 140). Additionally, or alternatively, the controller 130 may be configured to control access to the memory 140 and/or to provide a translation layer between the host device 110 and the memory 140 (e.g., for mapping logical addresses to physical addresses of a memory array). In some implementations, the controller 130 may translate a host interface command (e.g., a command received from the host device 110) into a memory interface command (e.g., a command for performing an operation on a memory array).

The controller 130 may include one or more components. In some implementations, one or more of these components are implemented as one or more instructions (e.g., firmware) executed by the controller 130. Alternatively, one or more of these components may be implemented as dedicated integrated circuits distinct from the controller 130.

One or more devices or components shown in FIG. 2 may be configured to perform operations described herein, such as one or more operations and/or methods described in connection with FIGS. 1-6. For example, the controller 130 may be configured to perform one or more operations and/or methods for the memory device 120.

The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. Additionally, or alternatively, a set of components (e.g., one or more components) shown in FIG. 2 may perform one or more operations described as being performed by another set of components shown in FIG. 2.

A ROM is a type of non-volatile memory used in an electronic device. Data stored in the ROM may not be electronically modified after a manufacture of the non-volatile memory. The ROM may be useful for storing firmware, which is typically not expected to require modification during a life of the electronic device.

In some cases, a ROM firmware may need to be patched (e.g., due to a failure or a vulnerability associated with the ROM firmware), which may serve to update the ROM firmware. In a first approach, patching the ROM firmware that is operational in an SOC may be based at least in part on an interceptor hardware mechanism. In a second approach, patching the ROM firmware that is operational in the SOC may be based at least in part on a CAM patch hardware mechanism.

In the first approach, interceptor hardware may intercept an access to defective ROM memory from a CPU, and the interceptor hardware may redirect the access to a patch code/data in an SRAM. A setup of the interceptor hardware may be performed by the ROM firmware relatively early in a boot sequence. Patch metadata and/or patch code may be stored in OTP memory. The ROM firmware may program the interceptor hardware with the patch metadata, and the ROM firmware may load the patch code into the SRAM. Since the interceptor hardware is enabled only slightly later in the boot sequence, initial ROM data may be rendered un-patchable.

In the first approach, the interceptor hardware may include a set of registers. A first register may be associated with a bad base (BadBase), a second register may be associated with a good base (GoodBase), and a third register may be associated with a bad length (BadLength). The bad base may represent an address of an instruction that is to be patched. The instruction may be one instruction or a group of instructions. The instruction may be a sequence of instructions in the ROM that need to be patched. The instruction may be considered to be a bad instruction. A base address of the bad instruction may be programmed into the first register. An alternative instruction, or patch code, that is to replace the bad instruction may be copied into a RAM. The good base may represent an address of the alternative instruction or patch code that is to replace the bad instruction. The alternative instruction or the patch code may correspond to a non-defective instruction. A base address of that patch code may be programmed into the second register. The bad length may indicate a length of a number of words (e.g., 32-bit words) that are to be patched. The bad length may be programmed into the third register.

The first approach may involve the following operations:

```
BadTop = BadBase + BadLength;
Offset = HADDRin − BadBase;
GoodAddress = GoodBase + Offset;
if ((HADDRin >= BadBase) & (HADDRin < BadTop) {
  HADDRout <= GoodAddress;
} else {
  HADDRout <= HADDRin;
}
```

In this example, BadTop represents an upper limit of a range of addresses that will be matched against an address issued by a processor, for a patch point, computed by patch hardware, Offset represents an offset of an address issued by the processor from a base of a ROM memory, computed by the patch hardware, HADDRin represents a full 32-bit address of an instruction in the ROM memory, issued by the processor, GoodAddress represents a full 32-bit address of patched instruction in a RAM memory, corresponding to a bad instruction in the ROM memory, and HADDRout represents a full 32-bit address that is sent out by the patch hardware (e.g., an unpatched address into the ROM memory or a patched address into the RAM memory).

In the first approach, in order for the patch to occur, the ROM may need to boot to a certain extent. A series of instructions may be programmed or hardwired into the ROM. On bootup, once all basic hardware initializations are done, a CPU may be released from reset, at which point the CPU may start executing from address zero of the ROM. For the interceptor patch to work, the ROM has to boot to a certain point, and then the ROM firmware may program the interceptor hardware. Patch code and patch metadata may be stored in OTP. The ROM firmware may read the OTP, parse the patch metadata, program registers, copy the patch code into the RAM, and then set the interceptor hardware to fetch the patch code. The interceptor hardware may have the limitation that a certain area of the ROM cannot be patched. When an issue exists in this area of the ROM that cannot be patched, the area remains untouchable and cannot be fixed, which may potentially affect an entire boot sequence (e.g., an entire chip may not boot up).

In the first approach, one instruction in the ROM may be patched with a complex patch stored in the RAM. The interceptor hardware may include a series of registers. For example, ten patch points may be available in the interceptor hardware. The ten patch points may be associated with ten bad base addresses, ten bad lengths, and ten good bases. Any number of registers may be programmed depending on a number of bugs to be patched. For each patch point, a set of ROM instructions may be replaced with a greater length of patch code in the RAM. In other words, the replacement may not necessarily be based on a one-to-one matching.

For example, one 32-bit instruction may be patched in the ROM, in which case the bad base may be programmed with an address of that particular instruction, and the bad length may be programmed to one, which may indicate that only one word needs to be patched. When the CPU issues a fetch to the address associated with the bad base, that address may be replaced with a good address (e.g., an address associated with the good base). Further, the RAM may respond with a new instruction, or a patched instruction, and the CPU may start executing the new instruction. In this case, the interceptor hardware may be able to utilize a relatively large patch code that is running on the RAM.

In the second approach, a CAM patching may occur via CAM patch hardware (e.g., address matching hardware) that intercepts an access to the ROM. When the address is present in a CAM table, matching data may be returned instead of the access to the ROM being forwarded. Patched instructions may be auto-loaded by the CAM hardware into a register file from the OTP memory before the CPU is released from a reset. The CAM patching may allow the ROM to be patched from a first address onwards. However, the CAM patch hardware may be capable of only matching one instruction at a time, such that one instruction cannot be replaced with a multi-instruction patch.

The second approach may involve the following operations:

```
if (HADDRin == BadBase) {
  HRDATA <= GoodInstruction/Data;
} else {
  HADDRout <= HADDRin;
}
```

In this example, HRDATA represents an instruction that is returned by either the ROM memory or from stored data in the CAM patch hardware.

The second approach may involve a table of registers with addresses and corresponding data. In the second approach, an address of a particular word (e.g., 32-bit word) in the ROM may need to be replaced with certain data, where that data may reside in the CAM patch hardware itself. When the CPU begins to execute and sends a series of fetches to the ROM, the table may be used to match incoming addresses to bad base addresses that are programmed in the CAM patch hardware. When a match is found, corresponding data may be returned by the CAM patch hardware itself. One word of ROM may be replaced only with one instruction of the patch (e.g., no complex patch is enabled). The table of registers (e.g., CAM patch hardware registers) may be programmed automatically by the CAM patch hardware during a boot sequence, which may occur even before the CPU is released from the reset. Data from the OTP may be transferred into the CAM patch hardware, where the data may be used to program the table of registers. The table of registers may be populated with the data and the instruction (e.g., bad address and good instruction). Since the table of registers are automatically programmed by the CAM patch hardware and then the CPU is released from the reset, even the first address or first instruction of the ROM may be patched using the CAM patch hardware.

During an early boot sequence, an issue related to a hardware error or a firmware error may prevent a successful subsystem boot. Further, a fix for the issue may require a replacement of one or more CPU instructions or word data with a patch. In some cases, the fix may not be possible using the interceptor hardware mechanism or the CAM patch hardware mechanism.

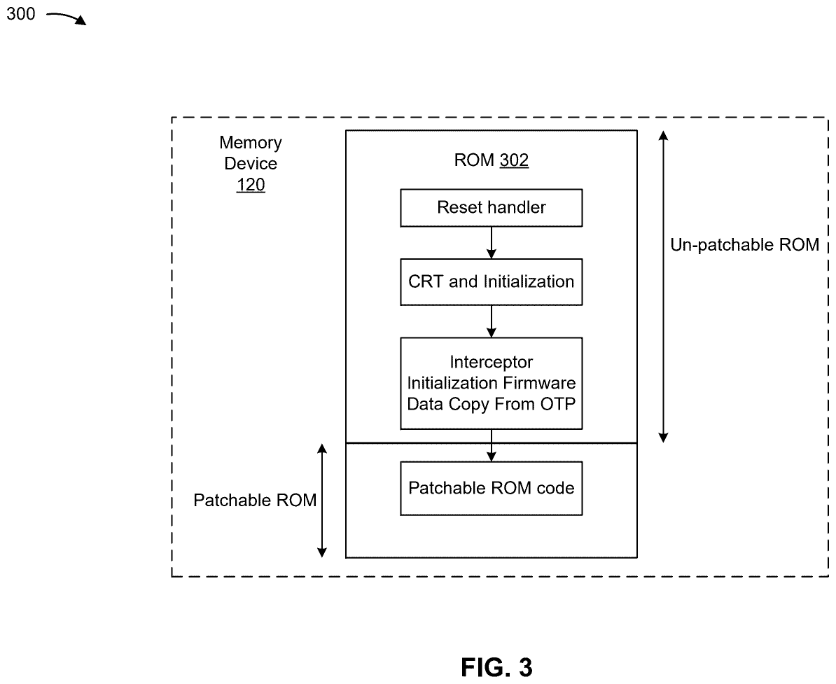

FIG. 3 is a diagram illustrating an example 300 of interceptor hardware with limitations, in accordance with the present disclosure. The example 300 includes the memory device 120, where the memory device 120 may include a ROM 302.

As shown in FIG. 3, a boot sequence of the ROM 302 may include an execution of a reset handler (or startup code), an initialization of the ROM 302, an interceptor firmware initialization, and a data copy from OTP. These steps of the boot sequence may involve initial ROM data (or initial ROM code), which may be un-patchable. Other ROM data may be patchable. As a result, one portion of the ROM 302 may be patchable using an interceptor hardware mechanism, and a remaining portion of the ROM 302 may not be patchable using the interceptor hardware mechanism.

As indicated above, FIG. 3 is provided as an example. Other examples may differ from what is described with regard to FIG. 3.

In some aspects, patch hardware (e.g., ROM patch hardware) may program itself with patch metadata. Patch code may be copied from OTP into an SRAM, and the copying may occur before a CPU is released from a reset. The patch hardware may load the patch metadata from the OTP and program hardware registers using the patch metadata. The patch hardware may load the patch code into the SRAM before the CPU is released from the reset. Since the patch code may be copied into the SRAM by the patch hardware, one single ROM word may be replaced with a patch of arbitrary complexity (limited only by an available patch storage space in the OTP). Such a process may occur before the CPU is released from the reset, such that a ROM may be patched from a first instruction onwards. The patch hardware may perform all necessary configurations to make the patch operational before the CPU is released from the reset. As a result, ROM firmware may be patched from the very first instruction with the patch of arbitrary complexity, thereby resulting in an improvement to the patch hardware.

In some aspects, by enabling the patch hardware to perform necessary configurations to make the patch operational before the CPU is released from the reset, the ROM firmware may be patched from the very first instruction. Regions of the ROM may not be un-patchable. The patch hardware may provide an ability to replace any ROM instruction/data with a complex patch. In other words, the patch hardware may not be limited to patching only one instruction at a time. As a result, a hardware mechanism to patch any part of the ROM firmware may result in an overall improved performance of a memory device.

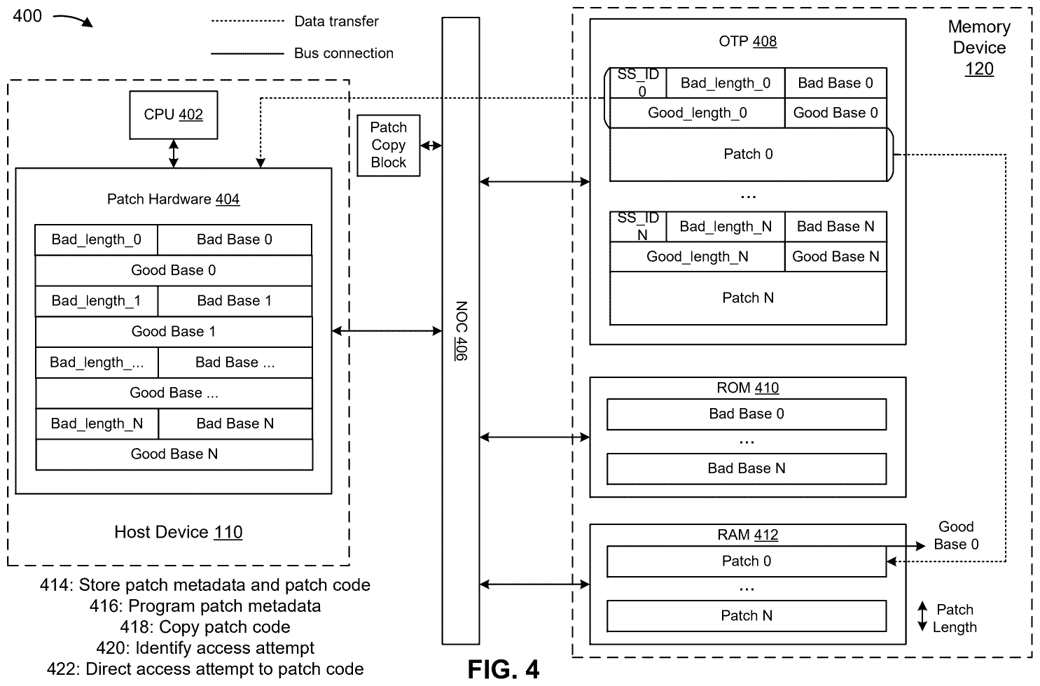

FIG. 4 is a diagram illustrating an example of a computing system 400 that includes interceptor hardware, in accordance with the present disclosure. The computing system 400 may include the host device 110, the memory device 120, and a network on chip (NOC) 406. The host device 110 may include a CPU 402 and patch hardware 404 (e.g., the interceptor hardware). The memory device 120 may include a one-time-programmable (OTP) memory 408, a ROM 410, and a RAM 412. The RAM 412 may be an SRAM. The patch hardware 404 may be a ROM patch hardware.

As shown by reference number 414, the computing system 400 may store patch metadata and patch code in the OTP memory 408. The patch metadata may include a bad base field to indicate an offset of a bad instruction from a base address of the ROM 410 that is to be patched. The patch metadata may include a bad length field to indicate a length of a number of bad instructions to be patched. The patch metadata may include a good base field to indicate an offset from a starting address of the RAM 412 at which the patch code is to be copied. The patch metadata may include a good length field to indicate a size of the patch code. The patch metadata may include a subsystem identifier (SSID) to indicate the CPU 402 that is associated with the patch code. The patch code may correspond to an instruction to patch the bad instruction in the ROM. The patch code may correspond to multiple instructions. In some cases, one or more patch codes may be stored contiguously from a start of a predefined patch area in the OTP memory 408.

As shown by reference number 416, the computing system 400 may program, before the CPU 402 is released from a reset, the patch metadata into the patch hardware 404. The patch metadata may be programmed into the patch hardware 404, before the CPU 402 is released from the reset, to enable the ROM patching to be operational before the CPU 402 is released from the reset, and to enable the ROM 410 to be patched starting from a first instruction of a boot sequence.

As shown by reference number 418, the computing system 400 may copy, before the CPU 402 is released from the reset, the patch code from the OTP memory 408 into the RAM 412. The patch code may be copied into the RAM 412, before the CPU 402 is released from the reset, to enable the ROM patching to be operational before the CPU 402 is released from the reset, and to enable the ROM 410 to be patched starting from the first instruction of the boot sequence. The patch code may be copied into the RAM 412 based at least in part on the good length field, and the good length field and the bad length field may be in terms of a number of words. The patch metadata may be programmed into the patch hardware 404 and the patch code may be copied into the RAM 412 based at least in part on the patch hardware 404 exiting a low power mode.

As shown by reference number 420, the computing system 400 may identify, based on the patch metadata, an access attempt issued by the CPU 402 to a bad instruction in the ROM 410, wherein the bad instruction is associated with ROM firmware. The access attempt to the bad instruction may be identified based at least in part on a match to the offset from the base address in the bad base field.

As shown by reference number 422, the computing system 400 may direct the access attempt to the patch code stored in the RAM 412, wherein the ROM firmware is patched based at least in part on the patch code. A fetch to the starting address indicated in the good base field may be issued in order to patch the ROM firmware with the patch code. In some cases, the bad instruction in the ROM 410 may be replaceable with the multiple instructions, when the patch code corresponds to the multiple instructions.

In some aspects, the CPU 402 may be able to access the patch hardware 404. The patch hardware 404 may include, for each patch point, a bad length, a bad base, and a good base. The patch hardware 404 may support N patch segments, where Nis a positive integer. The OTP 408 may store, for each patch point, an SSID, a bad length, a bad base, a good length, a good base, and a patch. The OTP memory 408 may support N patch segments. The ROM 410 may be associated with up to N bad bases. The RAM 412 may store up to N patches.

In some aspects, a bad base may refer to an offset of incorrect instruction(s) from a base address of the ROM 410 that needs to be patched. The bad base may refer to an offset of a bad instruction from the base address of the ROM 410. The patch hardware 404 may copy this field into a BAD_BASE_X register within the patch hardware 404. A bad length may refer to a length of a number of instructions that needs to be patched. The bad length may be a field that is in terms of 32-bit words. The bad length may indicate a number of words in the ROM 410 from a bad base offset needs to be patched. The patch hardware 404 may copy this field into a BAD_LENGTH_X register within the patch hardware 404. A good base may refer to an offset from a starting address of the RAM 412 at which patch code may be copied. The good base may indicate a location in the RAM 412 at which the patch code for this particular bad instruction resides. The patch code may be copied into the RAM 412. For example, good base 0 may represent a base address of patch 0. The patch hardware 404 may copy this field into a GOOD_BASE_X register within the patch hardware 404. A good length may refer to a size of the patch code in 32-bit words. The good length may indicate how many bytes of patch code are present in the OTP memory 408 immediately following this good length field. The patch hardware 404 may use this size to copy the patch code into the RAM 412. A patch may be a region that contains the instructions to patch the defective ROM instruction. The patch hardware 404 may copy this area into the RAM 412. The SSID may refer to a field that is used to identify the CPU 402 that is associated with the patch code. The SSID may be useful in scenarios involving multiple CPUs sharing the same OTP patch space. Each CPU may have its own dedicated RAM and ROM areas. The bad base, the bad length, the good base, the good length, the patch, and the SSID may be fields of one patch segment.

In some aspects, the OTP memory 408 may store the patch metadata and the patch code for each patch segment. The patch metadata may include the bad length, the bad base, the good length, the good base, and/or the SSID. The patch code may include the patch. The patch hardware 404 may program itself with the patch metadata, which may be fetched from the OTP memory 408. The patch hardware 404 may copy the patch code from the OTP memory 408 into the RAM 412, which may occur before the CPU 402 is released from a reset. One or more patches may be stored contiguously from a start of patch area in the OTP memory 408.

In some aspects, the patch hardware 404 may start parsing the OTP memory 408. The patch hardware 404 may parse the OTP memory 408 starting from a pre-allocated patch area. The patch hardware 404 may start from a base address and look for the bad length. When the bad length is non-zero, a valid patch may be stored in the OTP memory 408. The patch hardware 404 may fetch the bad base and program the bad base in the patch hardware 404. The patch hardware 404 may fetch the bad length and program the bad length in the patch hardware 404. The patch hardware 404 may fetch the good base and program the good base in the patch hardware 404. The patch hardware 404 may utilize the good length to transfer an associated number of bytes of patch code, immediately following the good length, into the RAM 412 at an offset pointed to by the good base. A first patch (or first patch code) may be programmed into the patch hardware 404 and also set up in the RAM 412. The patch hardware 404 may increment a pointer to a next location, which may start immediately after the first patch, and this process may be repeated. The process may stop at an end of the patch area or when the bad length is equal to zero, which may indicate that no more patches are available. The process may occur even before the CPU 402 is released from the reset, which may allow the ROM 410 to be patched from a very first instruction. Further, the ROM 410 may be patched with a complex patch, depending on the scenario.

In some aspects, a sequence of such data transfers (e.g., the patch hardware 404 programming itself with the patch metadata and copying the patch code from the OTP memory 408 into the RAM 412) may be performed during a cold boot and when a subsystem exits a low power mode (e.g., when ROM patch hardware is powered off while in the low power mode). After a setup that involves the sequence of data transfers, when the CPU 402 issues a fetch to a defective instruction (e.g., one of the address offset range specified by BAD_BASE_X and BAD_BASE_X registers), the patch hardware 404 may issue a fetch to an address stored in a corresponding GOOD_BASE_X register. The patch hardware 404 may perform a patch setup operation only when a BAD_LENGTH field of a patch segment is non-zero. The patch hardware 404 may use a GOOD_LENGTH field to reach a start of a next patch segment accounting for a length of the patch metadata. This process may continue until an area with a BAD_LENGTH field set to 0 is reached. When the BAD_LENGTH field of the first patch is 0, the hardware patch hardware 404 may skip the patching process. As a result, the ROM 410 may be patched from a very first instruction, and the patch hardware 404 may provide an ability to replace any ROM instruction/data with a complex patch (e.g., more than one instruction).

As indicated above, FIG. 4 is provided as an example. Other examples may differ from what is described with regard to FIG. 4.

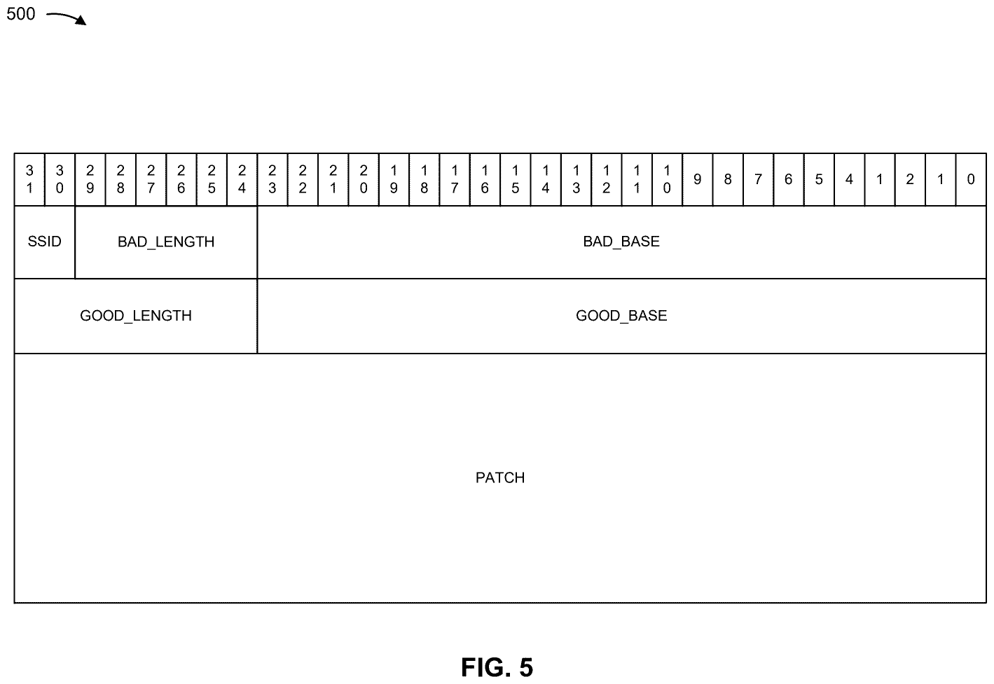

FIG. 5 is a diagram illustrating an example 500 of a patch layout in OTP memory, in accordance with the present disclosure.

As shown in FIG. 5, a patch segment may include a bad base, a bad length, a good base, a good length, a patch, and an SSID. The bad base may refer to an offset of incorrect instruction(s) from a base address of a ROM that needs to be patched. The bad length may refer to a length of a number of instructions that needs to be patched. The bad length may be a field that is in terms of 32-bit words. The good base may refer to an offset from a starting address of a RAM at which patch code may be copied. The good length may refer to a size of the patch code in 32-bit words. The patch may be a region that contains the instructions to patch the defective ROM instruction. The SSID may refer to a field that is used to identify a CPU that is associated with the patch code.

As indicated above, FIG. 5 is provided as an example. Other examples may differ from what is described with regard to FIG. 5.

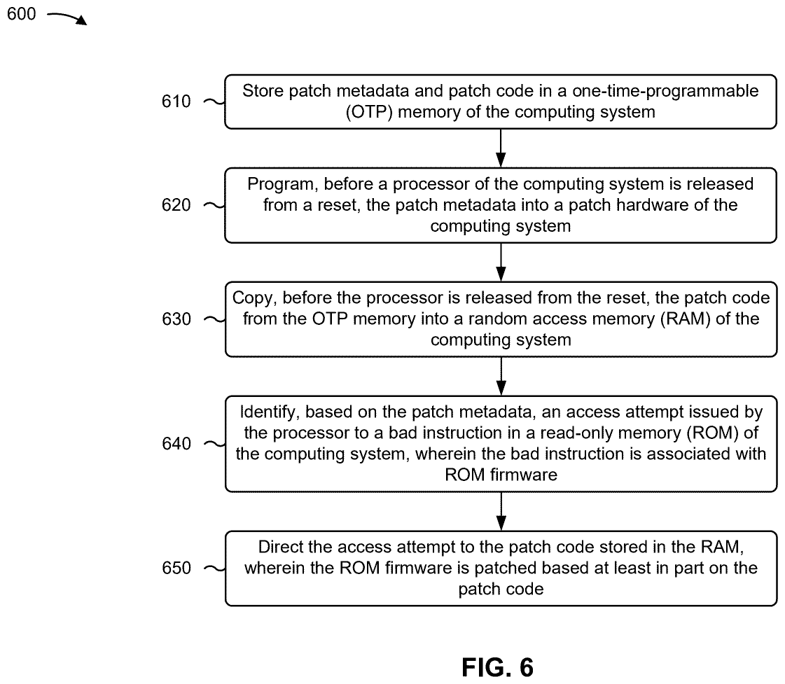

FIG. 6 is a flowchart of an example process 600 associated with patching ROM firmware. In some aspects, one or more process blocks of FIG. 6 are performed by a computing system (e.g., system 100). In some implementations, one or more process blocks of FIG. 6 are performed by another device or a group of devices separate from or including the computing system.

As shown in FIG. 6, process 600 may include storing patch metadata and patch code in an OTP memory of the computing system (block 610). For example, the computing system may store patch metadata and patch code in an OTP memory of the computing system, as described above.

As further shown in FIG. 6, process 600 may include programming, before a processor of the computing system is released from a reset, the patch metadata into a patch hardware of the computing system (block 620). For example, the computing system may program, before a processor of the computing system is released from a reset, the patch metadata into a patch hardware of the computing system, as described above.

As further shown in FIG. 6, process 600 may include copying, before the processor is released from the reset, the patch code from the OTP memory into a RAM of the computing system (block 630). For example, the computing system may copy, before the processor is released from the reset, the patch code from the OTP memory into a RAM of the computing system, as described above.

As further shown in FIG. 6, process 600 may include identifying, based on the patch metadata, an access attempt issued by the processor to a bad instruction in a ROM of the computing system, wherein the bad instruction is associated with ROM firmware (block 640). For example, the computing system may identify, based on the patch metadata, an access attempt issued by the processor to a bad instruction in a ROM of the computing system, wherein the bad instruction is associated with ROM firmware, as described above.

As further shown in FIG. 6, process 600 may include directing the access attempt to the patch code stored in the RAM, wherein the ROM firmware is patched based at least in part on the patch code (block 650). For example, the computing system may direct the access attempt to the patch code stored in the RAM, wherein the ROM firmware is patched based at least in part on the patch code, as described above.

Process 600 may include additional implementations, such as any single implementation or any combination of implementations described below and/or in connection with one or more other processes described elsewhere herein.

In a first implementation, programming the patch metadata into the patch hardware and copying the patch code into the RAM, before the processor is released from the reset, enables a ROM patching to be operational before the processor is released from the reset.

In a second implementation, alone or in combination with the first implementation, programming the patch metadata into the patch hardware and copying the patch code into the RAM, before the processor is released from the reset, enables the ROM to be patched starting from a first instruction of a boot sequence.

In a third implementation, alone or in combination with one or more of the first and second implementations, the patch metadata includes one or more of: a bad base field to indicate an offset of a bad instruction from a base address of the ROM that is to be patched, a bad length field to indicate a length of a number of bad instructions to be patched, a good base field to indicate an offset from a starting address of the RAM at which the patch code is to be copied, a good length field to indicate a size of the patch code, or a subsystem identifier to indicate the processor that is associated with the patch code.

In a fourth implementation, alone or in combination with one or more of the first through third implementations, process 600 includes copying the patch code into the RAM based at least in part on the good length field, and the good length field and the bad length field are in terms of a number of words.

In a fifth implementation, alone or in combination with one or more of the first through fourth implementations, process 600 includes identifying the access attempt to the bad instruction based at least in part on a match to the offset from the base address in the bad base field; and issuing a fetch to the starting address indicated in the good base field in order to patch the ROM firmware with the patch code

In a sixth implementation, alone or in combination with one or more of the first through fifth implementations, the patch code corresponds to an instruction to patch the bad instruction in the ROM.

In a seventh implementation, alone or in combination with one or more of the first through sixth implementations, the patch code corresponds to multiple instructions, and the bad instruction in the ROM is replaceable with the multiple instructions.

In an eighth implementation, alone or in combination with one or more of the first through seventh implementations, process 600 includes programming the patch metadata into the patch hardware and copying the patch code into the RAM based at least in part on the patch hardware exiting a low power mode.

In a ninth implementation, alone or in combination with one or more of the first through eighth implementations, process 600 includes storing one or more patch codes contiguously from a start of a predefined patch area in the OTP memory.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

The following provides an overview of some Aspects of the present disclosure:
Aspect 1: A method performed by a computing system, comprising: storing patch metadata and patch code in a one-time-programmable (OTP) memory of the computing system; programming, before a processor of the computing system is released from a reset, the patch metadata into a patch hardware of the computing system; copying, before the processor is released from the reset, the patch code from the OTP memory into a random access memory (RAM) of the computing system; identifying, based on the patch metadata, an access attempt issued by the processor to a bad instruction in a read-only memory (ROM) of the computing system, wherein the bad instruction is associated with ROM firmware; and directing the access attempt to the patch code stored in the RAM, wherein the ROM firmware is patched based at least in part on the patch code.
Aspect 2: The method of Aspect 1, further comprising: programming the patch metadata into the patch hardware and copying the patch code into the RAM, before the processor is released from the reset, to enable the ROM patching to be operational before the processor is released from the reset.
Aspect 3: The method of any of Aspects 1-2, further comprising: programming the patch metadata into the patch hardware and copying the patch code into the RAM, before the processor is released from the reset, to enable the ROM to be patched starting from a first instruction of a boot sequence.
Aspect 4: The method of any of Aspects 1-3, wherein the patch metadata includes one or more of: a bad base field to indicate an offset of a bad instruction from a base address of the ROM that is to be patched, a bad length field to indicate a length of a number of bad instructions to be patched, a good base field to indicate an offset from a starting address of the RAM at which the patch code is to be copied, a good length field to indicate a size of the patch code, or a subsystem identifier to indicate the processor that is associated with the patch code.
Aspect 5: The method of Aspect 4, further comprising: copying the patch code into the RAM based at least in part on the good length field, and the good length field and the bad length field are in terms of a number of words.
Aspect 6: The method of Aspect 4, further comprising: identifying the access attempt to the bad instruction based at least in part on a match to the offset from the base address in the bad base field; and issuing a fetch to the starting address indicated in the good base field in order to patch the ROM firmware with the patch code.
Aspect 7: The method of any of Aspects 1-6, wherein the patch code corresponds to an instruction to patch the bad instruction in the ROM.
Aspect 8: The method of any of Aspects 1-7, wherein the patch code corresponds to multiple instructions, and the bad instruction in the ROM is replaceable with the multiple instructions.
Aspect 9: The method of any of Aspects 1-8, further comprising: programming the patch metadata into the patch hardware and copying the patch code into the RAM based at least in part on the patch hardware exiting a low power mode.
Aspect 10: The method of any of Aspects 1-9, further comprising: storing one or more patch codes contiguously from a start of a predefined patch area in the OTP memory.
Aspect 11: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-10.
Aspect 12: An apparatus for wireless communication at a device, the apparatus comprising one or more memories and one or more processors coupled to the one or more memories, the one or more processors configured to cause the device to perform the method of one or more of Aspects 1-10.
Aspect 13: An apparatus for wireless communication, the apparatus comprising at least one means for performing the method of one or more of Aspects 1-10.
Aspect 14: A non-transitory computer-readable medium storing code for wireless communication, the code comprising instructions executable by one or more processors to perform the method of one or more of Aspects 1-10.
Aspect 15: A non-transitory computer-readable medium storing a set of instructions for wireless communication, the set of instructions comprising one or more instructions that, when executed by one or more processors of a device, cause the device to perform the method of one or more of Aspects 1-10.
Aspect 16: A device for wireless communication, the device comprising a processing system that includes one or more processors and one or more memories coupled with the one or more processors, the processing system configured to cause the device to perform the method of one or more of Aspects 1-10.
Aspect 17: An apparatus for wireless communication at a device, the apparatus comprising one or more memories and one or more processors coupled to the one or more memories, the one or more processors individually or collectively configured to cause the device to perform the method of one or more of Aspects 1-10.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computing system, comprising:
one or more components configured to:
store patch metadata and patch code in a one-time-programmable (OTP) memory of the computing system;
program, before a processor of the computing system is released from a reset, the patch metadata into a patch hardware of the computing system;
copy, before the processor is released from the reset, the patch code from the OTP memory into a random access memory (RAM) of the computing system;
identify, based on the patch metadata, an access attempt issued by the processor to a bad instruction in a read-only memory (ROM) of the computing system, wherein the bad instruction is associated with ROM firmware; and
direct the access attempt to the patch code stored in the RAM, wherein the ROM firmware is patched based at least in part on the patch code.

2. The computing system of claim 1, wherein the one or more components are configured to program the patch metadata into the patch hardware and copy the patch code into the RAM, before the processor is released from the reset, to enable the ROM patching to be operational before the processor is released from the reset.

3. The computing system of claim 1, wherein the one or more components are configured to program the patch metadata into the patch hardware and copy the patch code into the RAM, before the processor is released from the reset, to enable the ROM to be patched starting from a first instruction of a boot sequence.

4. The computing system of claim 1, wherein the patch metadata includes one or more of:
a bad base field to indicate an offset of a bad instruction from a base address of the ROM that is to be patched,
a bad length field to indicate a length of a number of bad instructions to be patched,
a good base field to indicate an offset from a starting address of the RAM at which the patch code is to be copied,
a good length field to indicate a size of the patch code, or
a subsystem identifier to indicate the processor that is associated with the patch code.

5. The computing system of claim 4, wherein the one or more components are configured to:
copy the patch code into the RAM based at least in part on the good length field, and the good length field and the bad length field are in terms of a number of words.

6. The computing system of claim 4, wherein the one or more components are configured to:
identify the access attempt to the bad instruction based at least in part on a match to the offset from the base address in the bad base field; and
issue a fetch to the starting address indicated in the good base field in order to patch the ROM firmware with the patch code.

7. The computing system of claim 1, wherein the patch code corresponds to an instruction to patch the bad instruction in the ROM.

8. The computing system of claim 1, wherein the patch code corresponds to multiple instructions, and the bad instruction in the ROM is replaceable with the multiple instructions.

9. The computing system of claim 1, wherein the one or more components are configured to program the patch metadata into the patch hardware and copy the patch code into the RAM based at least in part on the patch hardware exiting a low power mode.

10. The computing system of claim 1, wherein the one or more components are configured to store one or more patch codes contiguously from a start of a predefined patch area in the OTP memory.

11. A method performed by a computing system, comprising:
storing patch metadata and patch code in a one-time-programmable (OTP) memory of the computing system;
programming, before a processor of the computing system is released from a reset, the patch metadata into a patch hardware of the computing system;
copying, before the processor is released from the reset, the patch code from the OTP memory into a random access memory (RAM) of the computing system;
identifying, based on the patch metadata, an access attempt issued by the processor to a bad instruction in a read-only memory (ROM) of the computing system, wherein the bad instruction is associated with ROM firmware; and
directing the access attempt to the patch code stored in the RAM, wherein the ROM firmware is patched based at least in part on the patch code.

12. The method of claim 11, further comprising:
programming the patch metadata into the patch hardware and copying the patch code into the RAM, before the processor is released from the reset, to enable the ROM patching to be operational before the processor is released from the reset.

13. The method of claim 11, further comprising:
programming the patch metadata into the patch hardware and copying the patch code into the RAM, before the processor is released from the reset, to enable the ROM to be patched starting from a first instruction of a boot sequence.

14. The method of claim 11, wherein the patch metadata includes one or more of:
a bad base field to indicate an offset of a bad instruction from a base address of the ROM that is to be patched,
a bad length field to indicate a length of a number of bad instructions to be patched,
a good base field to indicate an offset from a starting address of the RAM at which the patch code is to be copied,
a good length field to indicate a size of the patch code, or
a subsystem identifier to indicate the processor that is associated with the patch code.

15. The method of claim 14, further comprising:
copying the patch code into the RAM based at least in part on the good length field, and the good length field and the bad length field are in terms of a number of words.

16. The method of claim 14, further comprising:
identifying the access attempt to the bad instruction based at least in part on a match to the offset from the base address in the bad base field; and
issuing a fetch to the starting address indicated in the good base field in order to patch the ROM firmware with the patch code.

17. The method of claim 11, wherein the patch code corresponds to an instruction to patch the bad instruction in the ROM.

18. The method of claim 11, wherein the patch code corresponds to multiple instructions, and the bad instruction in the ROM is replaceable with the multiple instructions.

19. The method of claim 11, further comprising:
programming the patch metadata into the patch hardware and copying the patch code into the RAM based at least in part on the patch hardware exiting a low power mode; and
storing one or more patch codes contiguously from a start of a predefined patch area in the OTP memory.

20. A non-transitory computer-readable medium storing a set of instructions, comprising:
one or more instructions that, when executed by one or more processors of a computing system, cause the computing system to:
store patch metadata and patch code in a one-time-programmable (OTP) memory of the computing system;
program, before a processor of the computing system is released from a reset, the patch metadata into a patch hardware of the computing system;
copy, before the processor is released from the reset, the patch code from the OTP memory into a random access memory (RAM) of the computing system;
identify, based on the patch metadata, an access attempt issued by the processor to a bad instruction in a read-only memory (ROM) of the computing system, wherein the bad instruction is associated with ROM firmware; and
direct the access attempt to the patch code stored in the RAM, wherein the ROM firmware is patched based at least in part on the patch code.
